(19) United States
(12) Patent Application Publication
(10) Pub. No.: US 2026/0319536 A1
(43) Pub. Date: Oct. 15, 2026

(54) CONVERTER, SENSING CIRCUIT AND ELECTRONIC DEVICE

(71) Applicant: AAC Technologies Pte. Ltd., Singapore (SG)

(72) Inventors: Yangmeng Chang, Singapore (SG); Siewseong Tan, Singapore (SG); Tiongkee Chua, Singapore (SG)

(21) Appl. No.: 19/177,674

(22) Filed: Apr. 14, 2025

(51) Int. Cl. G05F 1/575

(52) U.S. Cl. CPC G05F 1/575

(57) ABSTRACT

A converter, a sensing circuit and an electronic device, the converter includes: a feedback loop; a plurality of constant current elements; a first field effect transistor; and a transistor. The plurality of constant current elements includes a first constant current element, a second constant current element and a third constant current element. The feedback loop is connected to the first constant current element, and the feedback loop is connected to the first field effect transistor. The second constant current element is connected to the first field effect transistor, the third constant current element is connected to the transistor, and the third constant current element generates a low noise reference voltage. The converter improves the LNA integrated noise and the PSRR performance.

### TECHNICAL FIELD

The present disclosure relates to the field of electronic technology, and in particular, to a converter, a sensing circuit and an electronic device.

### BACKGROUND

A bandgap reference is connected to a filter, the filter is connected to a first terminal of a low noise amplifier (LNA), and a second terminal of the LNA is connected to an output terminal for outputting. In this case, a target bandwidth of the filter requires a larger chip area. In the related art, the operating supply of a converter is 0.9V, the LNA integrated noise is -104dBV, and the power supply rejection ratio (PSRR) is 29dB at a frequency of 1KHz. PSRR is an important parameter to measure the ability of a circuit to suppress ripple in the input power supply, and can represent the logarithmic ratio of the output ripple to the input ripple. In the related art, the LNA integrated noise is low, and the PSRR performance is poor.

### SUMMARY

In view of this, the present disclosure provides a converter, a sensing circuit and an electronic device, aiming to improving the LNA integrated noise and the PSRR performance.

In an aspect, an embodiment of the present disclosure provides a converter, including: a feedback loop; a plurality of constant current elements; a first field effect transistor; and a transistor. The plurality of constant current elements include a first constant current element, a second constant current element and a third constant current element. The feedback loop is connected to the first constant current element, and the feedback loop is connected to the first field effect transistor. The second constant current element is connected to the first field effect transistor, the third constant current element is connected to the transistor, and the third constant current element generates a low noise reference voltage.

As an improvement, the feedback loop includes an amplifier and a second field effect transistor; a non-inverting input terminal of the amplifier is connected to a bandgap reference voltage, and an inverting input terminal of the amplifier is respectively connected to the first constant current element and the second field effect transistor, and an output terminal of the amplifier is respectively connected to the second field effect transistor and the first field effect transistor; and the second field effect transistor is connected to ground.

As an improvement, the second field effect transistor is an NMOS transistor and the first field effect transistor is an NMOS transistor, the inverting input terminal of the amplifier is connected to a drain of the second field effect transistor; the output terminal of the amplifier is respectively connected to a gate of the second field effect transistor and a gate of the first field effect transistor; and a body and a source of the second field effect transistor are connected to ground.

As an improvement, the first field effect transistor is an NMOS transistor, the second constant current element is connected to a drain of the first field effect transistor, and a body and a source of the first field effect transistor are connected to ground.

As an improvement, the feedback loop includes an amplifier and a third field effect transistor, and the third field effect transistor includes a first sub-transistor and a second sub-transistor; and a non-inverting input terminal of the amplifier is connected to the first sub-transistor, an inverting input terminal of the amplifier is respectively connected to the first constant current element and the second sub-transistor, an output terminal of the amplifier is respectively connected to the second sub-transistor and the first field effect transistor, and the first sub-transistor is connected to the second sub-transistor.

As an improvement, the first sub-transistor and the second sub-transistor each are a PMOS transistor, the first field effect transistor is a PMOS transistor, the non-inverting input terminal of the amplifier is connected to a gate and a drain of the first sub-transistor, the inverting input terminal of the amplifier is connected to a drain of the second sub-transistor, the output terminal of the amplifier is respectively connected to a gate of the second sub-transistor and a gate of the first field effect transistor, and a body and a source of the first sub-transistor are connected to a body and a source of the second sub-transistor.

As an improvement, the second constant current element is connected to a drain of the first field effect transistor, and the second constant current element is connected to ground; and the converter further includes a fourth constant current element, the fourth constant current element is connected to the drain and the gate of the first sub-transistor, the fourth constant current element is connected to the non-inverting input terminal of the amplifier, and the fourth constant current element is connected to ground.

As an improvement, the transistor is a field effect transistor or a bipolar junction transistor, the field effect transistor is an NMOS transistor or a PMOS transistor, and the bipolar junction transistor is an NPN transistor or a PNP transistor.

In another aspect, an embodiment of the present disclosure provides a sensing circuit, including a converter including: a feedback loop; a plurality of constant current elements; a first field effect transistor; and a transistor. The plurality of constant current elements include a first constant current element, a second constant current element and a third constant current element. The feedback loop is connected to the first constant current element, and the feedback loop is connected to the first field effect transistor. The second constant current element is connected to the first field effect transistor, the third constant current element is connected to the transistor, and the third constant current element generates a low noise reference voltage.

In another aspect, an embodiment of the present disclosure provides an electronic device, including a converter including: a feedback loop; a plurality of constant current elements; a first field effect transistor; and a transistor. The plurality of constant current elements include a first constant current element, a second constant current element and a third constant current element. The feedback loop is connected to the first constant current element, and the feedback loop is connected to the first field effect transistor. The second constant current element is connected to the first field effect transistor, the third constant current element is connected to the transistor, and the third constant current element generates a low noise reference voltage.

In the technical solutions provided by the embodiments of the present disclosure, the converter includes a feedback loop, a plurality of constant current elements, a first field effect transistor and a transistor; the plurality of constant current elements include a first constant current element, a second constant current element and a third constant current element; the feedback loop is connected to the first constant current element, and the feedback loop is connected to the first field effect transistor; the second constant current element is connected to the first field effect transistor, the third constant current element is connected to the transistor, and the third constant current element generates a low noise reference voltage. In the technical solutions provided by the embodiments of the present disclosure, the converter can improve the LNA integrated noise and the PSRR performance.

### BRIEF DESCRIPTION OF DRAWINGS

In order to better illustrate technical solutions in embodiments of the present disclosure or in the related art, the accompanying drawings used in the embodiments and in the related art are briefly introduced as follows. It should be noted that the drawings described as follows are merely part of the embodiments of the present disclosure, and other drawings can also be acquired by those skilled in the art without paying creative efforts.

FIG. 1 is a schematic diagram of a converter in the related art;

FIG. 2 is a schematic diagram of a converter according to an embodiment of the present disclosure;

FIGS. 3A-3H each are a schematic diagram of a converter according to an embodiment of the present disclosure; and

FIG. 4 is a schematic diagram of a converter according to an embodiment of the present disclosure.

### DESCRIPTION OF EMBODIMENTS

For better illustrating technical solutions of the present disclosure, embodiments of the present disclosure will be described in detail as follows with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term "and/or" used herein is merely an association relationship describing associated objects, indicating that there may be three relationships, for example, A and/or B may indicate that three cases, i.e., A existing individually, A and B existing simultaneously, B existing individually. In addition, the character "/" herein generally indicates that the related objects before and after the character form an "or" relationship.

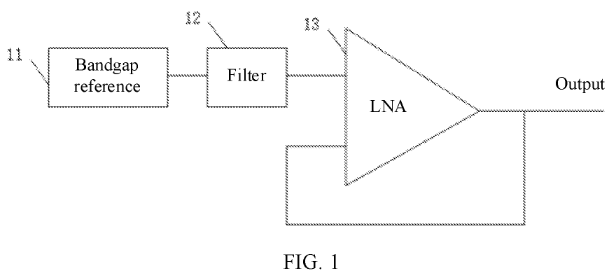

In the related art, a converter is provided, and FIG. 1 is a schematic diagram of a converter in the related art. As shown in FIG. 1, the converter includes: a bandgap reference 11, a filter 12, and a low noise amplifier (LNA) 13. The bandgap reference 11 is connected to the filter 12, the filter 12 is connected to a first terminal of the LNA 13, and a second terminal of the LNA 13 is connected to an output terminal for outputting. In this case, a target bandwidth of the filter 12 requires a larger chip area. In the related art, the operating supply of the converter is 0.9V, the LNA integrated noise is -104dBV, and the power supply rejection ratio (PSRR) is 29dB at a frequency of 1KHz. The PSRR is an important parameter to measure the ability of a circuit to suppress ripple in the input power supply, and can represent the logarithmic ratio of the output ripple to the input ripple. In the related art, the LNA integrated noise is low and the PSRR performance is poor.

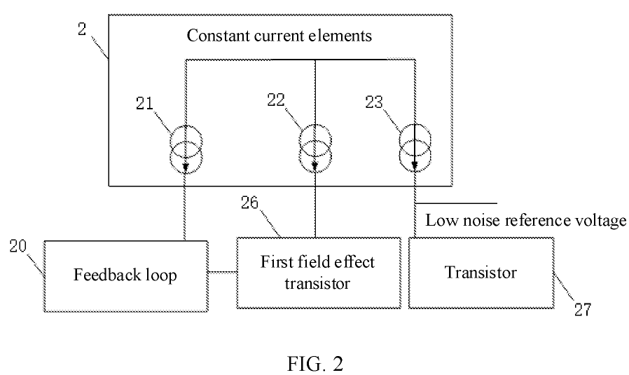

In order to solve the technical problems in the related art, an embodiment of the present disclosure provides a converter that can optimize the noise at a low power supply voltage in ultra-low power design based on a current based converter. FIG. 2 is a schematic diagram of a converter according to an embodiment of the present disclosure. As shown in FIG. 2, the converter includes: a feedback loop 20, a plurality of constant current elements 2, a first field effect transistor 26 and a transistor 27.

The plurality of constant current elements 2 include a first constant current element 21, a second constant current element 22, and a third constant current element 23. The first constant current element 21 may have a bias current IBIAS, the second constant current element 22 may have a bias current IBIAS, and the third constant current element 23 may have a bias current M*IBIAS.

The feedback loop 20 can be configured to eliminate noise. The feedback loop 20 is connected to the first constant current element 21, and the feedback loop 20 is connected to the first field effect transistor 26.

The second constant current element 22 is connected to the first field effect transistor 26, the third constant current element 23 is connected to the transistor 27, and the third constant current element 23 generates a low noise reference voltage.

In an embodiment of the present disclosure, the transistor may be a field effect transistor or a bipolar junction transistor (BJT); the field effect transistor may be an NMOS transistor or a PMOS transistor, and the bipolar transistor may be an NPN transistor or a PNP transistor.

In the technical solutions provided by the embodiments of the present disclosure, the converter includes a feedback loop, a plurality of constant current elements, a first field effect transistor and a transistor; the plurality of constant current elements include a first constant current element, a second constant current element and a third constant current element; the feedback loop is connected to the first constant current element, and the feedback loop is connected to the first field effect transistor; the second constant current element is connected to the first field effect transistor, the third constant current element is connected to the transistor, and the third constant current element generates a low noise reference voltage. In the technical solutions provided by the embodiments of the present disclosure, the converter can improve the LNA integrated noise and the PSRR performance.

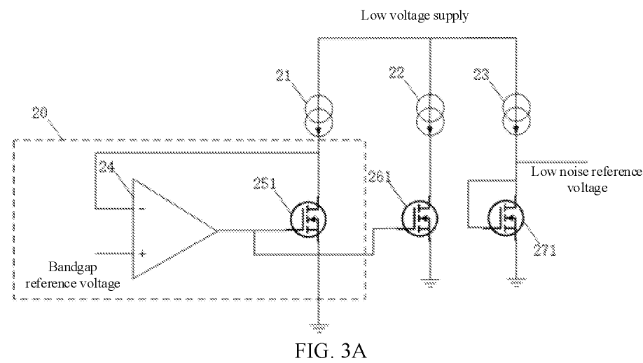

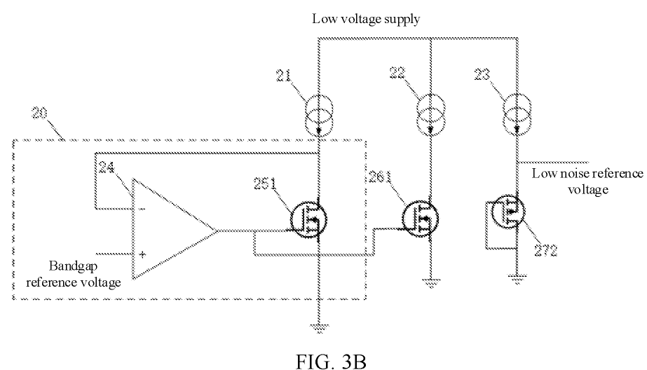

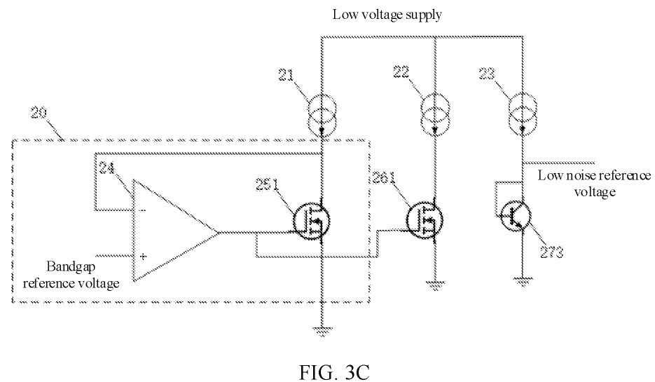

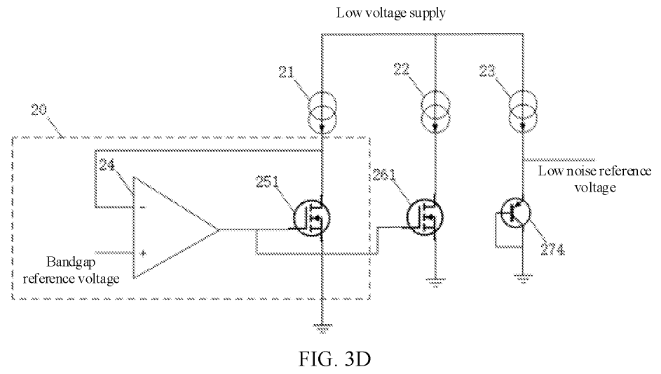

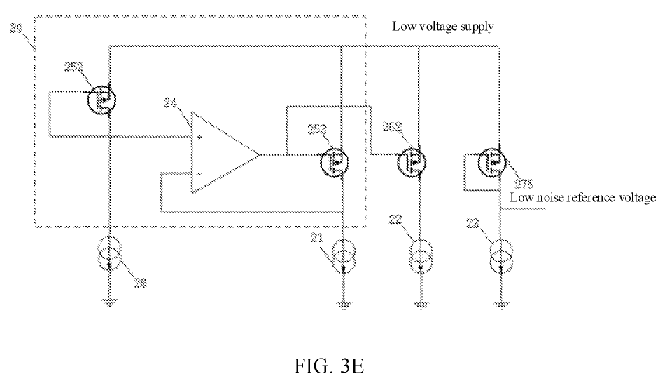

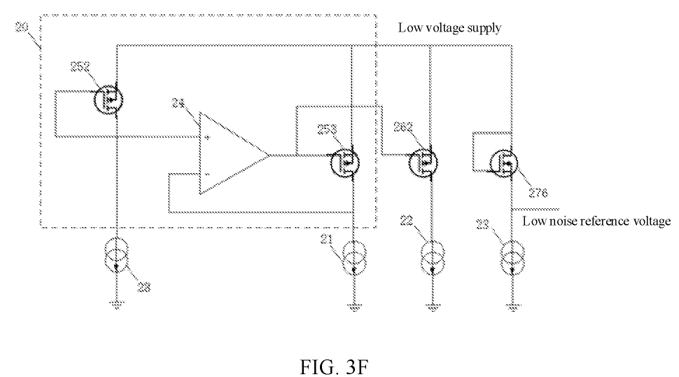

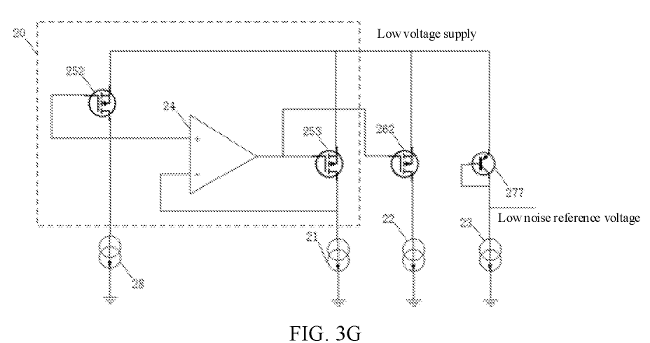

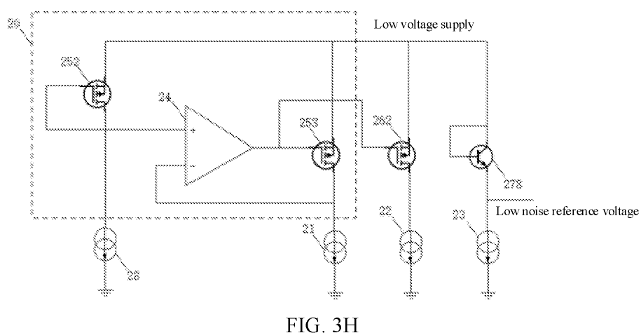

In combination with FIGS. 2, 3A-3H are provided and each are a schematic diagram of a converter according to an embodiment of the present disclosure. As shown in FIG. 3A, the converter includes: a feedback loop 20, a first constant current element 21, a second constant current element 22, a third constant current element 23, a first field effect transistor 261 and a transistor 271. The first field effect transistor 261 is an NMOS transistor, and the transistor 271 is an NMOS transistor.

The feedback loop 20 includes an amplifier 24 and a second field effect transistor 251, and the second field effect transistor 251 is an NMOS transistor.

A non-inverting input terminal of the amplifier 24 is connected to a bandgap reference voltage, and an inverting input terminal of the amplifier 24 is respectively connected to the first constant current element 21 and the second field effect transistor 251. An output terminal of the amplifier 24 is respectively connected to the second field effect transistor 251 and the first field effect transistor 261, and the second field effect transistor 251 is connected to ground.

The second constant current element 22 is connected to the first field effect transistor 261, the first field effect transistor 261 is connected to ground, the third constant current element 23 is connected to the transistor 271, the transistor 271 is connected to ground, and the third constant current element 23 generates a low noise reference voltage.

In an example, the inverting input terminal of the amplifier 24 is connected to a drain of the second field effect transistor 251, the output terminal of the amplifier 24 is respectively connected to a gate of the second field effect transistor 251 and a gate of the first field effect transistor 261, and a body and a source of the second field effect transistor 251 are connected to ground; the second constant current element 22 is connected to a drain of the first field effect transistor 261, and a body and a source of the first field effect transistor 261 are connected to ground; and the third constant current element 23 is connected to a drain and a gate of the transistor 271, and a body and a source of the transistor 271 are connected to ground.

As shown in FIG. 3B, the converter includes: a feedback loop 20, a first constant current element 21, a second constant current element 22, a third constant current element 23, a first field effect transistor 261 and a transistor 272. The first field effect transistor 261 is an NMOS transistor, and the transistor 272 is a PMOS transistor.

The feedback loop 20 includes an amplifier 24 and a second field effect transistor 251, and the second field effect transistor 251 is an NMOS transistor.

A non-inverting input terminal of the amplifier 24 is connected to a bandgap reference voltage, and an inverting input terminal of the amplifier 24 is respectively connected to the first constant current element 21 and the second field effect transistor 251. An output terminal of the amplifier 24 is respectively connected to the second field effect transistor 251 and the first field effect transistor 261, and the second field effect transistor 251 is connected to ground.

The second constant current element 22 is connected to the first field effect transistor 261, the first field effect transistor 261 is connected to ground, the third constant current element 23 is connected to the transistor 272, the transistor 272 is connected to ground, and the third constant current element 23 generates a low noise reference voltage.

In an example, the inverting input terminal of the amplifier 24 is connected to a drain of the second field effect transistor 251, the output terminal of the amplifier 24 is respectively connected to a gate of the second field effect transistor 251 and a gate of the first field effect transistor 261, and a body and a source of the second field effect transistor 251 are connected to ground; the second constant current element 22 is connected to a drain of the first field effect transistor 261, and a body and a source of the first field effect transistor 261 are connected to ground; and the third constant current element 23 is connected to a source and a body of the transistor 272, and a gate and a drain of the transistor 272 are connected to ground.

As shown in FIG. 3C, the converter includes: a feedback loop 20, a first constant current element 21, a second constant current element 22, a third constant current element 23, a first field effect transistor 261 and a transistor 273. The first field effect transistor 261 is an NMOS transistor, and the transistor 273 is an NPN transistor.

The feedback loop 20 includes an amplifier 24 and a second field effect transistor 251, and the second field effect transistor 251 is an NMOS transistor.

A non-inverting input terminal of the amplifier 24 is connected to a bandgap reference voltage, and an inverting input terminal of the amplifier 24 is respectively connected to the first constant current element 21 and the second field effect transistor 251. An output terminal of the amplifier 24 is respectively connected to the second field effect transistor 251 and the first field effect transistor 261, and the second field effect transistor 251 is connected to ground.

The second constant current element 22 is connected to the first field effect transistor 261, the first field effect transistor 261 is connected to ground, the third constant current element 23 is connected to the transistor 273, the transistor 273 is connected to ground, and the third constant current element 23 generates a low noise reference voltage.

In an example, the inverting input terminal of the amplifier 24 is connected to a drain of the second field effect transistor 251, the output terminal of the amplifier 24 is respectively connected to a gate of the second field effect transistor 251 and a gate of the first field effect transistor 261, and a body and a source of the second field effect transistor 251 are connected to ground; the second constant current element 22 is connected to a drain of the first field effect transistor 261, and a body region and a source of the first field effect transistor 261 are connected to ground; and the third constant current element 23 is connected to a base and a collector of the transistor 273, and an emitter of the transistor 273 is connected to ground.

As shown in FIG. 3D, the converter includes: a feedback loop 20, a first constant current element 21, a second constant current element 22, a third constant current element 23, a first field effect transistor 261 and a transistor 274. The first field effect transistor 261 is an NMOS transistor, and the transistor 274 is a PNP transistor.

The feedback loop 20 includes an amplifier 24 and a second field effect transistor 251, and the second field effect transistor 251 is an NMOS transistor.

A non-inverting input terminal of the amplifier 24 is connected to a bandgap reference voltage, and an inverting input terminal of the amplifier 24 is respectively connected to the first constant current element 21 and the second field effect transistor 251. An output terminal of the amplifier 24 is respectively connected to the second field effect transistor 251 and the first field effect transistor 261, and the second field effect transistor 251 is connected to ground.

The second constant current element 22 is connected to the first field effect transistor 261, the first field effect transistor 261 is connected to ground, the third constant current element 23 is connected to the transistor 274, the transistor 274 is connected to ground, and the third constant current element 23 generates a low noise reference voltage.

In an example, the inverting input terminal of the amplifier 24 is connected to a drain of the second field effect transistor 251, the output terminal of the amplifier 24 is respectively connected to a gate of the second field effect transistor 251 and a gate of the first field effect transistor 261, and a body and a source of the second field effect transistor 251 are connected to ground; the second constant current element 22 is connected to a drain of the first field effect transistor 261, and a body and a source of the first field effect transistor 261 are connected to ground; and the third constant current element 23 is connected to an emitter of the transistor 274, and a base and a collector of the transistor 274 are connected to ground.

As shown in FIG. 3E, the converter includes: a feedback loop 20, a first constant current element 21, a second constant current element 22, a third constant current element 23, a first field effect transistor 262 and a transistor 275. The first field effect transistor 262 is a PMOS transistor, and the transistor 275 is a PMOS transistor.

The feedback loop 20 includes an amplifier 24 and a third field effect transistor, and the third field effect transistor includes a first sub-transistor 252 and a second sub-transistor 253. The first sub-transistor and the second sub-transistor each are a PMOS transistor.

A non-inverting input terminal of the amplifier 24 is connected to the first sub-transistor 252, an inverting input terminal of the amplifier 24 is respectively connected to the first constant current element 21 and the second sub-transistor 253, an output terminal of the amplifier 24 is respectively connected to the second sub-transistor 253 and the first field effect transistor 262, the first sub-transistor 252 is connected to the second sub-transistor 253, and the first constant current element 21 is connected to ground.

In an example, the non-inverting input terminal of the amplifier 24 is connected to a gate and a drain of the first sub-transistor 252, the inverting input terminal of the amplifier 24 is connected to a drain of the second sub-transistor 253, the output terminal of the amplifier 24 is respectively connected to a gate of the second sub-transistor 253 and a gate of the first field effect transistor 262, and a body and a source of the first sub-transistor 252 are connected to a body region and a source of the second sub-transistor 253.

The second constant current element 22 is connected to a drain of the first field effect transistor 262, and the second constant current element is connected to ground. The third constant current element 23 is connected to a drain and a gate of the transistor 275, and the third constant current element 23 is connected to ground.

The converter further includes a fourth constant current element 28. The fourth constant current element 28 is connected to a drain and a gate of the first sub-transistor 252, and the fourth constant current element 28 is connected to the non-inverting input terminal of the amplifier 24, and the fourth constant current element 28 is connected to ground.

As shown in FIG. 3F, the converter includes a feedback loop 20, a first constant current element 21, a second constant current element 22, a third constant current element 23, a first field effect transistor 262 and a transistor 276. The first field effect transistor 262 is a PMOS transistor, and the transistor 276 is an NMOS transistor.

The feedback loop 20 includes an amplifier 24 and a third field effect transistor, and the third field effect transistor includes a first sub-transistor 252 and a second sub-transistor 253. The first sub-transistor and the second sub-transistor are each a PMOS transistor.

A non-inverting input terminal of the amplifier 24 is connected to the first sub-transistor 252, an inverting input terminal of the amplifier 24 is respectively connected to the first constant current element 21 and the second sub-transistor 253, an output terminal of the amplifier 24 is respectively connected to the second sub-transistor 253 and the first field effect transistor 262, the first sub-transistor 252 is connected to the second sub-transistor 253, and the first constant current element 21 is connected to ground.

In an example, the non-inverting input terminal of the amplifier 24 is connected to a gate and a drain of the first sub-transistor 252, the inverting input terminal of the amplifier 24 is connected to a drain of the second sub-transistor 253, the output terminal of the amplifier 24 is respectively connected to a gate of the second sub-transistor 253 and a gate of the first field effect transistor 262, and a body and a source of the first sub-transistor 252 are connected to a body and a source of the second sub-transistor 253.

The second constant current element 22 is connected to a drain of the first field effect transistor 262, and the second constant current element is connected to ground. The third constant current element 23 is connected to a body and a source of the transistor 276, and the third constant current element 23 is connected to ground.

The converter further includes a fourth constant current element 28. The fourth constant current element 28 is connected to a drain and a gate of the first sub-transistor 252, the fourth constant current element 28 is connected to the non-inverting input terminal of the amplifier 24, and fourth constant current element 28 is connected to ground.

As shown in FIG. 3G, the converter includes: a feedback loop 20, a first constant current element 21, a second constant current element 22, a third constant current element 23, a first field effect transistor 262 and a transistor 277. The first field effect transistor 262 is a PMOS transistor, and the transistor 277 is a PNP transistor.

The feedback loop 20 includes an amplifier 24 and a third field effect transistor, and the third field effect transistor includes a first sub-transistor 252 and a second sub-transistor 253. The first sub-transistor and the second sub-transistor are each a PMOS transistor.

A non-inverting input terminal of the amplifier 24 is connected to the first sub-transistor 252, an inverting input terminal of the amplifier 24 is respectively connected to the first constant current element 21 and the second sub-transistor 253, an output terminal of the amplifier 24 is respectively connected to the second sub-transistor 253 and the first field effect transistor 262, the first sub-transistor 252 is connected to the second sub-transistor 253, and the first constant current element 21 is connected to ground.

In an example, the non-inverting input terminal of the amplifier 24 is connected to a gate and a drain of the first sub-transistor 252, the inverting input terminal of the amplifier 24 is connected to a drain of the second sub-transistor 253, the output terminal of the amplifier 24 is respectively connected to a gate of the second sub-transistor 253 and a gate of the first field effect transistor 262, and a body and a source of the first sub-transistor 252 are connected to a body and a source of the second sub-transistor 253.

The second constant current element 22 is connected to a drain of the first field effect transistor 262, and the second constant current element is connected to ground. The third constant current element 23 is connected to a base and a collector of the transistor 277, and the third constant current element 23 is connected to ground.

The converter further includes a fourth constant current element 28. The fourth constant current element 28 is connected to a drain and a gate of the first sub-transistor 252, the fourth constant current element 28 is connected to the non-inverting input terminal of the amplifier 24, and the fourth constant current element 28 is connected to ground.

As shown in FIG. 3H, the converter includes: a feedback loop 20, a first constant current element 21, a second constant current element 22, a third constant current element 23, a first field effect transistor 262 and a transistor 278. The first field effect transistor 262 is a PMOS transistor, and the transistor 278 is an NPN transistor.

The feedback loop 20 includes an amplifier 24 and a third field effect transistor, and the third field effect transistor includes a first sub-transistor 252 and a second sub-transistor 253. The first sub-transistor and the second sub-transistor are each a PMOS transistor.

A non-inverting input terminal of the amplifier 24 is connected to the first sub-transistor 252, an inverting input terminal of the amplifier 24 is respectively connected to the first constant current element 21 and the second sub-transistor 253, an output terminal of the amplifier 24 is connected to the second sub-transistor 253 and the first field effect transistor 262, the first sub-transistor 252 is connected to the second sub-transistor 253, and the first constant current element 21 is connected to ground.

In an example, the non-inverting input terminal of the amplifier 24 is connected to a gate and a drain of the first sub-transistor 252, the inverting input terminal of the amplifier 24 is connected to a drain of the second sub-transistor 253, the output terminal of the amplifier 24 is respectively connected to a gate of the second sub-transistor 253 and a gate of the first field effect transistor 262, and a body and a source of the first sub-transistor 252 are connected to a body and a source of the second sub-transistor 253.

The second constant current element 22 is connected to a drain of the first field effect transistor 262, and the second constant current element is connected to ground. The third constant current element 23 is connected to an emitter of the transistor 278, and the third constant current element 23 is connected to ground.

The converter further includes a fourth constant current element 28. The fourth constant current element 28 is connected to a drain and a gate of the first sub-transistor 252, the fourth constant current element 28 is connected to the non-inverting input terminal of the amplifier 24, and the fourth constant current element 28 is connected to ground.

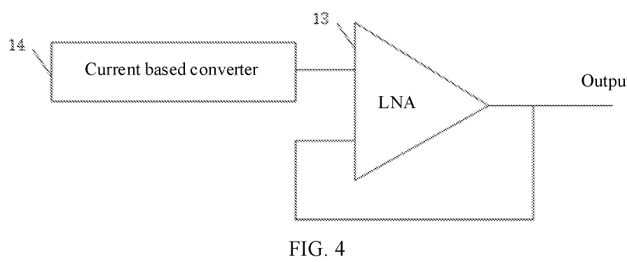

FIG. 4 is a schematic diagram of a converter according to an embodiment of the present disclosure. As shown in FIG. 4, a current based converter 14 is connected to a first terminal of the LNA 13 based on a low noise reference voltage, and a second terminal of the LNA 13 is connected to an output terminal for outputting. The operating supply of the converter is 0.9V, the LNA integrated noise is -109dBV, and the PSRR is 78dB at a frequency of 1KHz. The technical solutions according to the embodiments of the present disclosure improve the integrated noise of the LNA by 5dBV and improves the PSRR performance by 49dB.

In the technical solutions provided by the embodiments of the present disclosure, the converter includes a feedback loop, a plurality of constant current elements, a first field effect transistor and a transistor; the plurality of constant current elements include a first constant current element, a second constant current element and a third constant current element; the feedback loop is connected to the first constant current element, and the feedback loop is connected to the first field effect transistor; the second constant current element is connected to the first field effect transistor, the third constant current element is connected to the transistor, and the third constant current element generates a low noise reference voltage. In the technical solutions provided by the embodiments of the present disclosure, the converter can improve the LNA integrated noise and the PSRR performance.

In the technical solutions provided by the embodiments of the present disclosure, the LNA system noise is improved to meet high signal-to-noise ratio design at a low supply voltage of 0.9V.

In the technical solutions provided by the embodiments of the present disclosure, the converter improves start up time and stable time with current based charged.

In the technical solutions provided by the embodiments of the present disclosure, the chip area is small, the power consumption is low, the supply voltage is low, the design is scalable for wide supply operating range, the noise induction is low, and the PSRR performance is good.

An embodiment of the present disclosure provides a sensing circuit including the converter described above. It can be applied to a capacitive sensing circuit, an accelerometer, a gyroscope or a microphone.

An embodiment of the present disclosure provides an electronic device, including the converter described above. For example, the electronic device may include: a medical hearing aid, an Internet of Things (IoT) device, a True Wireless Stereo (TWS), a smart phone and a feature phone, a teleconferencing system, a digital camera, a Bluetooth headset, a video phone, or a tablet computer.

The above-described embodiments are merely preferred embodiments of the present disclosure and are not intended to limit the present disclosure. Any modifications, equivalent substitutions and improvements made within the principle of the present disclosure shall fall into the protection scope of the present disclosure.

What is claimed is:

1. A converter, comprising:
a feedback loop;
a plurality of constant current elements;
a first field effect transistor; and
a transistor,
wherein the plurality of constant current elements comprise a first constant current element, a second constant current element and a third constant current element;
the feedback loop is connected to the first constant current element, and the feedback loop is connected to the first field effect transistor; and
the second constant current element is connected to the first field effect transistor, the third constant current element is connected to the transistor, and the third constant current element generates a low noise reference voltage.

2. The converter as described in claim 1,
wherein the feedback loop comprises an amplifier and a second field effect transistor;
a non-inverting input terminal of the amplifier is connected to a bandgap reference voltage, and an inverting input terminal of the amplifier is respectively connected to the first constant current element and the second field effect transistor, and an output terminal of the amplifier is respectively connected to the second field effect transistor and the first field effect transistor; and
the second field effect transistor is connected to ground.

3. The converter as described in claim 2, wherein the second field effect transistor is an NMOS transistor and the first field effect transistor is an NMOS transistor, the inverting input terminal of the amplifier is connected to a drain of the second field effect transistor; the output terminal of the amplifier is respectively connected to a gate of the second field effect transistor and a gate of the first field effect transistor; and a body and a source of the second field effect transistor are connected to ground.

4. The converter as described in claim 1, wherein the first field effect transistor is an NMOS transistor, the second constant current element is connected to a drain of the first field effect transistor, and a body and a source of the first field effect transistor are connected to ground.

5. The converter as described in claim 1,
wherein the feedback loop comprises an amplifier and a third field effect transistor, and the third field effect transistor comprises a first sub-transistor and a second sub-transistor; and
a non-inverting input terminal of the amplifier is connected to the first sub-transistor, an inverting input terminal of the amplifier is respectively connected to the first constant current element and the second sub-transistor, an output terminal of the amplifier is respectively connected to the second sub-transistor and the first field effect transistor, and the first sub-transistor is connected to the second sub-transistor.

6. The converter as described in claim 5, wherein the first sub-transistor and the second sub-transistor each are a PMOS transistor, the first field effect transistor is a PMOS transistor, the non-inverting input terminal of the amplifier is connected to a gate and a drain of the first sub-transistor, the inverting input terminal of the amplifier is connected to a drain of the second sub-transistor, the output terminal of the amplifier is respectively connected to a gate of the second sub-transistor and a gate of the first field effect transistor, and a body and a source of the first sub-transistor are connected to a body and a source of the second sub-transistor.

7. The converter as described in claim 6,
wherein the second constant current element is connected to a drain of the first field effect transistor, and the second constant current element is connected to ground; and
the converter further comprises a fourth constant current element, the fourth constant current element is connected to the drain and the gate of the first sub-transistor, the fourth constant current element is connected to the non-inverting input terminal of the amplifier, and the fourth constant current element is connected to ground.

8. The converter as described in claim 1, wherein the transistor is a field effect transistor or a bipolar junction transistor, the field effect transistor is an NMOS transistor or a PMOS transistor, and the bipolar junction transistor is an NPN transistor or a PNP transistor.

9. A sensing circuit, comprising a converter comprising:
a feedback loop;
a plurality of constant current elements;
a first field effect transistor; and
a transistor,
wherein the plurality of constant current elements comprise a first constant current element, a second constant current element and a third constant current element;
the feedback loop is connected to the first constant current element, and the feedback loop is connected to the first field effect transistor; and
the second constant current element is connected to the first field effect transistor, the third constant current element is connected to the transistor, and the third constant current element generates a low noise reference voltage.

10. An electronic device, comprising a converter comprising:
a feedback loop;
a plurality of constant current elements;
a first field effect transistor; and
a transistor,
wherein the plurality of constant current elements comprise a first constant current element, a second constant current element and a third constant current element;
the feedback loop is connected to the first constant current element, and the feedback loop is connected to the first field effect transistor; and
the second constant current element is connected to the first field effect transistor, the third constant current element is connected to the transistor, and the third constant current element generates a low noise reference voltage.
